(19) United States
(12) Patent Application Publication
(10) Pub. No.: US 2008/0155399 A1
(43) Pub. Date: Jun. 26, 2008

(54) System and method for indexing a document that includes a misspelled word

(75) Inventor: Ambles Kock, Richmond Hill (CA)

Correspondence Address: BRINKS HOFER GILSON & LIONE / YAHOO! OVERTURE, P.O. BOX 10395, CHICAGO, IL, 60610, US

(73) Assignee: YAHOO! Inc.

(21) Appl. No.: 11/642,476

(22) Filed: Dec. 20, 2006

(51) Int. Cl. G06F 17/00; G06F 7/00

(52) U.S. Cl. 715/259; 715/257; 707/100

(57) ABSTRACT

Systems and methods are disclosed for indexing a document such as a webpage that includes one or more misspelled words based on an index classification of the document. Generally, a document is received and it is determined whether a word in the document is spelled incorrectly. If the word in the document is spelled incorrectly, a first set of candidate words and a confidence score associated with each of the first set of candidate words is generated based on whether the word is a common misspelling or a culture-based misspelling of the word. Based on one or more index classifications of the document, a second set of one or more candidate words, which is a subset of the first set of candidate words, and a confidence score associated with each of the second set of one or more candidate words is generated. The received document is then indexed with at least one word of the second set of candidate words. The document may also be indexed with the actual spelling of the word in the document.

### BACKGROUND

Search engines such as Yahoo! often employ robots or web crawlers to locate and copy webpages on the Internet, and to index the copied webpages so that the search engine may quickly provide hyperlinks (“links”) to the indexed webpages in response to search queries. Robots or web crawlers often index webpages based on factors such as the meaning of specific words within a webpage, a number of times specific words occur in the webpage, a location of specific words in the webpage, and various associations between specific words within the webpage.

Currently, when a spelling of a word in a webpage is incorrect, a robot or web crawler may not index the webpage accurately according to the meaning intended by the author of the webpage. For example, in a webpage regarding telecommunications, the word “telephone” may be spelled incorrectly. Due to the misspelling of the word telephone, a robot or web crawler would not associate the correct spelling of the word telephone with the webpage when the robot or web crawler indexes the webpage. Therefore, when a searcher submits a search query to a search engine related to the word telephone, the search engine would not return the webpage in the search results due to the fact the webpage was not associated with the correct spelling of the word telephone when the webpage was indexed. Accordingly, it is desirable to develop systems and methods to better index documents such as webpages according to the meaning intended by the author of the webpage when one or more words are not spelled correctly in the webpage.

### BRIEF DESCRIPTION OF THE DRAWINGS

FIG. 1 is a block diagram of one embodiment of a system for indexing a document that includes a misspelled word; and

FIG. 2 is a flow chart of one embodiment of a method for indexing a document that includes a misspelled word.

### DETAILED DESCRIPTION OF THE DRAWINGS

The present disclosure is directed to systems and methods for indexing a document such as a webpage that includes one or more misspelled words. The disclosed systems and methods generally index a document that includes one or more misspelled words by automatically correcting a spelling of a misspelled word, based in part on a classification of the document, when the document is indexed for a search engine. Automatically correcting the spelling of one or more words in a document, based in part on a classification of the document, when the document is indexed allows search engines to more accurately index documents in a manner that reflects the meaning intended by the author who created the document.

Generally, search engines employ robots or web crawlers that search the Internet to locate, copy, and index documents. The robots or web crawlers may index documents such as a webpage, a Microsoft Word document, an Adobe PDF document, or any other type of document submitted to a search engine or that may be publicly available on the Internet. Documents are indexed for a search engine so that the search engine may quickly provide search results including hyperlinks (“links”) to one or more documents in response to a search query. For example, a robot or web crawler may locate, copy, and index a webpage regarding telecommunications. The webpage may include the word “telephone” one or more times in the webpage. Based on factors such as where the word telephone appears in the webpage, a number of times the word telephone appears in the webpage, and any associations between the word telephone and other words in the webpage, the robot or web crawler may associate the word telephone with the webpage when the webpage is indexed. Therefore, if a searcher submits a search query to the search engine including the word telephone, the search engine may return search results including a link to the webpage associated with the word telephone.

Continuing with the example above, if an author of the webpage misspells the word telephone in the webpage, the robot or web crawler will not correctly associate the word telephone with the webpage when the webpage is indexed even though the author may have intended to use the correct spelling of the word in the webpage. For example, when indexing the webpage, the robot or web crawler may associate the incorrect spelling of the word telephone that appears in the webpage with the webpage when the webpage is indexed, or the robot or web crawler may not associate the incorrect spelling of the word telephone with the webpage at all. Therefore, when a searcher submits a search query including the correct spelling of the word telephone, the search engine may not provide search results including a link to the webpage due to the fact the webpage is not associated with the correct spelling of the word telephone. It will be appreciated that the systems and methods disclosed below provide a way to automatically correct a spelling of a misspelled word in a document such as a webpage based on an index classification of a document so that a correct spelling of a misspelled word in a document is associated with the document when the document is indexed for a search engine.

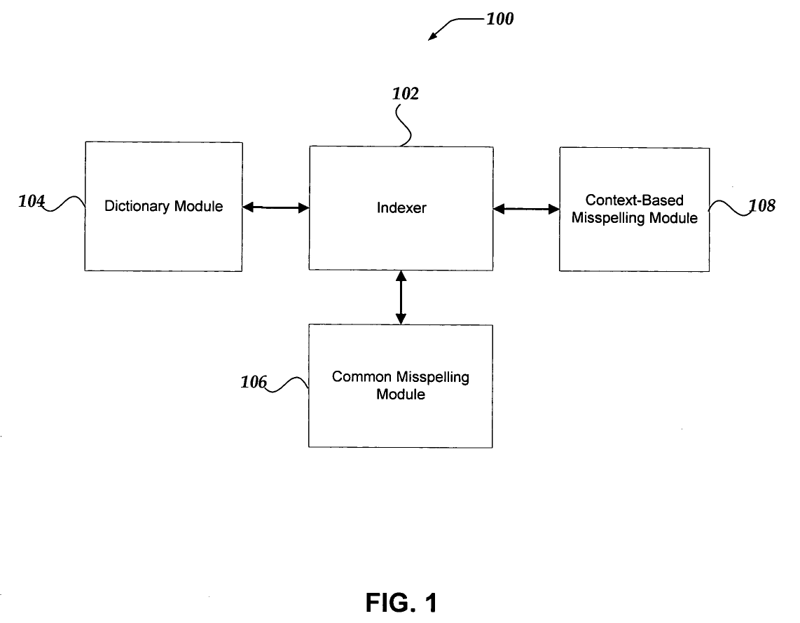

FIG. 1 is a block diagram of one embodiment of a system for indexing a document such as a webpage that includes one or more misspelled words. The system 100 includes an indexer 102, a dictionary module 104, a common misspelling module 106, and a context-based misspelling module 108. The indexer 102, dictionary module 104, common misspelling module 106, and context-based misspelling module 108 typically communicate with each other over one or more external or internal networks. The indexer 102, dictionary module 104, common misspelling module 106, and context-based misspelling module 108 may be implemented as software code stored on a computer-readable medium and running in conjunction with a processor such as a single server, a plurality of servers, or any other type of computing device known in the art.

In general, when the indexer 102 receives a document such as a webpage that has been submitted to a search engine, or located and copied by a robot or web crawler of the search engine, the indexer 102 accesses the dictionary module 104 to determine if the spelling of any of the words in the document is incorrect. As explained in more detail below, if the spelling of any of the words in the document is incorrect, the indexer 102 accesses the common misspelling module 106 to obtain a first set of candidate words related to the word that is incorrectly spelled in the document and a confidence score associated with each of the first set of candidate words. The common misspelling module 106 generates the first set of candidate words and associated confidence scores based on whether the word that is incorrectly spelled in the document is a common misspelling of the word or a culture-based misspelling of the word. A culture-based misspelling is a word that is spelled differently in the same language in two different countries, but that has the same meaning. For example, the word “behavior” in the United Sates is spelled “behavior” in the United Kingdom.

After receiving the first set of candidate words and their associated confidence scores, the indexer 102 accesses the context-based misspelling module 108 to obtain a second set of candidate words related to the misspelled word in the document and the first set of candidate words, and a confidence score associated with each of the second set of candidate words. As explained in more detail below, the context-based misspelling module 108 generates the second set of candidate words based on factors such as an index classification of the document, the first set of candidate words, the confidence scores associated with each of the first set of candidate words, and one or more words associated with an index classification of the document.

The indexer 102 receives the second set of candidate words and associated confidence scores from the context-based misspelling module 108, and may index the document with the actual spelling of the word in the document and at least one word of the second set of candidate words.

As summarized above, the indexer 102 may receive a document for indexing from systems such as a search engine, a robot, or a web crawler. Documents may be submitted to a search engine for indexing, or documents may be located and copied on the Internet by a robot or a web crawler. The document may be a webpage, a Microsoft Word document, an Adobe PDF document, or any other type of digital document submitted to a search engine or available to the public on the Internet. Before indexing the document, the indexer 102 communicates with the dictionary module 104 to determine whether the spelling of any of the words in the document is incorrect.

The dictionary module 104 may include one or more digital dictionaries, or may access one or more digital dictionaries, so that the dictionary module 104 may check the spelling of words in a document against a digital dictionary and identify words not appearing the digital dictionary. In one embodiment, the indexer 102 may submit the spelling of words individually to the dictionary module 104, and the dictionary module 104 returns whether the spelling of the word is incorrect. However, in other embodiments, the indexer 102 may submit an entire document, or groupings of spellings of words, to the dictionary module 104 and the dictionary module 104 returns which of the submitted spellings of words is incorrect.

If the indexer 102 receives an indication that one or more of the submitted spellings of words in incorrect, the indexer 102 communicates with the common misspelling module 106 to obtain a first set of candidate words and a confidence score associated with each word of the first set of candidate words. The common misspelling module 106 determines whether a spelling of a word that was indicated by the dictionary module 104 to be incorrect is a common misspelling of the word or a culture-based misspelling of the word. In one implementation, the common misspelling module 106 determines whether the spelling of a word is a common misspelling of the word or a culture-based misspelling of the word by comparing the spelling of the word from the document against a database. The database associates a correct spelling of a word with one or more common misspellings of the word, and associates a correct spelling of a word in one country, such as the United States, with a correct but different spelling of the word in another country, such as the United Kingdom. It will be appreciated that the above-described database may be a single database, or distributed over multiple databases.

Based on whether the actual spelling of the word in the document is a common misspelling of the word or a culture-based misspelling of the word, the common misspelling module 106 generates a first set of candidate words associated with the actual spelling of the word in the document and a confidence score associated with each of the first set of candidate words. For example, if the common misspelling module 106 determines the spelling “principul” is a common misspelling of the word “principle” and a common misspelling of the word “principal,” the common misspelling module 106 determines a first set of candidate words related to the spelling “principul” that includes the word “principle” and the word “principal.”

Continuing with the example above, the common misspelling module 106 also determines a confidence score associated with the word “principle” and a confidence score associated with the word “principal.” A confidence score is an indication of a level of confidence that a misspelled word should be correctly spelled in a given manner. Typically, a confidence score measures a number of edits necessary to change a first string into a second string. For example, a confidence score associated with the word “principle” measures a number of edits necessary to change the word “principul” into the word “principle.” Similarly, a confidence score associated with the word “principal” measures a number of edits necessary to change the word “principul” into the word “principal.”

In some implementations, the confidence score may be modified based on a self-learning feedback system that uses click-through data from users to establish when a user searches for a term with a first spelling and clicks-through a search listing including the term with a second spelling. The confidence score may additionally be modified based on a layout of a typically keyboard such that a word misspelled with a first letter that is spelled correctly with a second letter will have a higher confidence score when the first and second letters are located near each other on a layout of a typical keyboard than when the first and second letters are not located near each other on a layout of a typical keyboard.

The common misspelling module 106 returns the first set of candidate words and related confidence scores to the indexer 102. The indexer 102 communicates the first set of candidate words and related confidence scores to the context-based misspelling module 108 to obtain a second set of candidate words based on one or more index classifications of the document, the first set of candidate words, and a confidence score associated with each of the second set of candidate words. As known in the art, systems such as a search engine may classify documents into one or more categories for indexing based on factors such as words in a document, where specific words appear in a document, a number of times specific words appear in a document, and associations between different words in a document. For example, a search engine may classify a document such as a webpage in index classifications such as telecommunications, automotive, travel, finance, business, or any other category desired by the search engine.

Typically, a system such as a search engine will store a plurality of words associated with each index classification. In one implementation, a search engine may store a plurality of words that are associated with the most documents in a given index classification category. Alternatively, a search engine may store each word in a dictionary and the one or more index classifications associated with each word. Using the plurality of words associated with the one more index classifications of a document, when the context-based misspelling module 108 receives the first set of candidate words and related confidence scores, the context-based misspelling module 108 may compare each of the words of the first set of candidate words to the plurality of words associated with the one or more index classifications of the document to be indexed. Based on the relationships between the words of the first set of candidate words and the words associated with the one or more index classifications of the document to be indexed, the context-based module 108 generates a second set of candidate words related to the word misspelled in the document and a confidence score associated with each word of the second set of candidate words. It will be appreciated that the second set of candidate words is a subset of the first set of candidate words.

In one implementation, the context-based module 108 generates the second set of candidate words by determining which words of the first set of candidate words are also one of the plurality of words associated with the one or more index classifications of the document to be indexed. In other words, the second set of candidate words will include any word of the first set of candidate words that is also a word associated with the one or more index classifications of the document to be indexed. The second set of candidate words will not include any word of the first set of candidate words that is not a word associated with the one or more index classifications of the document to be indexed.

In one implementation, a confidence score of a word in the second set of candidate words is determined based on factors such as a confidence score of the word with respect to the first set of candidate words, a number of index classifications that the document to be indexed and the word are both associated with, a number of words that each index classifications that the document is to be indexed in is associated with, and a number of times the word appears in the document.

The context-based misspelling module 108 returns the second set of candidate words and related confidence scores to the indexer 102. The indexer 102 indexes the document with at least one word of the second set of candidate words based on the confidence scores associated with the second set of candidate words. In one implementation, the indexer 102 indexes the document with the word of the second set of candidate words with the highest corresponding confidence score. However, the indexer 102 may index the document with any number of words of the second set of candidate words such as five words of the second set of candidate words with the highest corresponding confidence scores.

In addition to indexing the document with at least one of the words of the second set of candidate words, the indexer 102 may also index the document with the incorrect spelling of the word in the document. The indexer 102 may index the document with the incorrect spelling of the word in the event the author actually intended to use the actual spelling of the word in the document, or in the event the document contained a word that the dictionary module 104 incorrectly identified as a misspelled word.

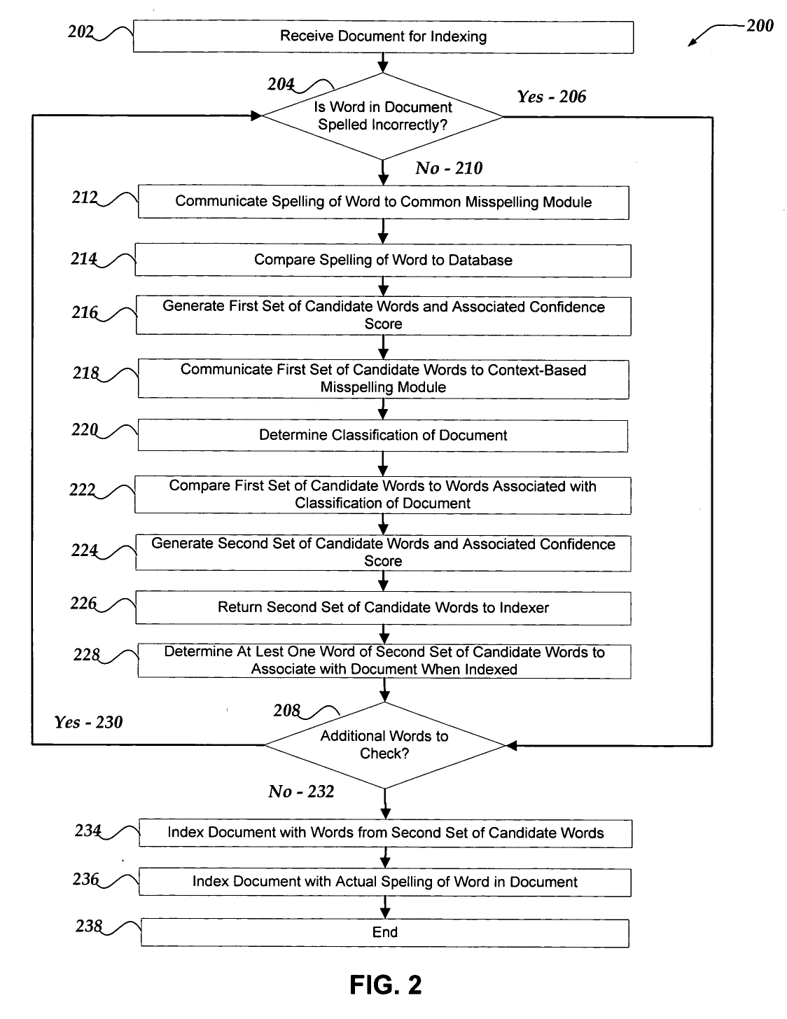

FIG. 2 is a flow chart of one embodiment of a method for indexing a document that includes a misspelled word. An indexer receives a document from a system such as search engine, a robot, or a crawler at step 202. As discussed above, the document may be a webpage, a Microsoft Word document, an Adobe PDF document, or any other type of digital document submitted to a search engine or available to the public on the Internet.

The indexer communicates with a dictionary module at step 204 to determine whether a spelling of a word in the document is correct. The dictionary module may check the spelling of the word against one or more digital dictionaries to determine if the spelling of the word is correct. If the dictionary module determines that the spelling of the word is correct (206), the method proceeds to step 208 where the indexer determines whether the spelling of any additional words in the document should be verified as explained in more detail below. However, if the dictionary module determines that the spelling of the word is not correct (210), the indexer communicates the spelling of the word to a common misspelling module at step 212.

The common misspelling module compares the received spelling of the word against a database at step 214 to determine whether the spelling of the word is a common misspelling of the word or a culture-based misspelling of the word. Based on whether the spelling of the word is a common misspelling of the word or a culture-based misspelling of the word, the common misspelling module generates a first set of candidate words and a confidence score associated with each word of the first set of candidate words at step 216. In one implementation, a confidence score of a word of the first set of candidate words is determined based on a number of edits necessary to change the received spelling of the word into the word of the first set of candidate words.

The indexer communicates the first set of candidate words and their associated confidence scores to the context-based misspelling module at step 218. Before or after the indexer communicates the first set of candidate words and their associated confidence scores to the context-based misspelling module, one or more index classifications of the document is determined as known in the art at step 220. The context-based misspelling module compares one or more words of the first set of candidate words to a plurality of words associated with the determined one or more index classifications of the document at step 222. In some implementations, the plurality of words associated with the determined one or more index classifications of the document may be one or more words that a number of documents having the same index classification have been associated with when indexed by a search engine.

Based on the plurality of words associated with the determined one or more classifications of the document and the first set of candidate terms, the context-based misspelling module generates a second set of candidate words and a confidence score associated with each of the second set of candidate words at step 224. It will be appreciated that the second set of candidate words is a subset of the first set of candidate words.

As discussed above, the second set of candidate words may be generated by determining which words of the first set of candidate words is also a word associated with one or more index classifications of the document to be indexed. Additionally, a confidence score associated with a word of the second set of candidate words is determined based on factors such as a confidence score of the word with respect to the first set of candidate words, a number of index classifications that the document to be indexed and the word are both associated with, a number of words that each index classification that the document is to be indexed in is associated with, and a number of times the word appears in the document.

The context-based misspelling module returns the second set of candidate words and their associated confidence score to the indexer at step 226, and the indexer determines at least one word of the second set of candidate words to associate with the document when the document is indexed at step 228. In one implementation, the indexer may determine to index the document with the word of the second set of candidate words with the highest correspondence confidence score. However, in other implementations the indexer may determine to index the document with any number of words of the second set of candidate words.

The method proceeds to step 208 where the indexer determines whether the spelling of any additional words in the document should be verified. If the indexer determines that the spelling of an additional word in the document should be verified (230), the method proceeds to step 204 and the above-described process is repeated. However, if the indexer determines that the spelling of an additional word in the document does not need to be verified (232), the indexer indexes the document at step 234 with one or more words determined at step 228. In some embodiments, the indexer may additionally index the document at step 236 with the actual spelling of one or more words in the document that the dictionary module indicated is incorrect at 204 before the method ends at step 238.

FIGS. 1 and 2 disclose systems and methods for indexing a document such as a webpage that includes one or more misspelled words based on an index classification of the document. The disclosed systems and methods generally index a document that includes one or more misspelled words by automatically correcting a spelling of the misspelled words based on detected common misspellings or culture-based misspellings of a word, and a classification of the document to be indexed. Automatically correcting the spelling of one or more words in a document when the document is indexed allows search engines to more accurately index documents in a manner that reflects the intended meaning of the author who created the document.

It is therefore intended that the foregoing detailed description be regarded as illustrative rather than limiting, and that it be understood that it is the following claims, including all equivalents, that are intended to define the spirit and scope of this invention.

1. A computer-implemented method for indexing a document, the method comprising the steps of:
determining whether a spelling of a word in a document to be indexed is incorrect;
determining one or more index classifications of the document;
generating one or more candidate words based on the spelling of the word in the document and the determined one or more index classifications of the document; and
indexing the document with at least one word of the one or more candidate words.

2. The method of claim 1, wherein determining whether the spelling of the word in the document to be indexed is incorrect comprises:
comparing the spelling of the word in the document to one or more digital dictionaries.

3. The method of claim 1, wherein generating one or more candidate words based on the spelling of the word in the document and the determined one or more index classifications of the document comprises:
generating a first set of one or more candidate words based on whether the spelling of the word in the document is at least one of a common misspelling of a word or a culture-based misspelling of the word; and
generating a second set of one or more candidate words based on the first set of one or more candidate words and the determined one or more index classifications of the document.

4. The method of claim 3, wherein generating one or more candidate words based on the spelling of the words in the document and the determined one or more index classifications of the document further comprises:
for each candidate word of the first set of one or more candidate words, determining a confidence score associated with the candidate word;
for each candidate word of the second set of one or more candidate words, determining a confidence score associated with the candidate word;
wherein the second set of one or more candidate words is generated based on the first set of one or more candidate words, the confidence score associated with each of the first set of one or more candidate words, and the determined one or more index classifications of the document; and
wherein the document is indexed with at least one word of the one or more candidate words based on the confidence score associated with each of the second set of one or more candidate words.

5. The method of claim 4, wherein a confidence score associated with a word of the first set of one or more candidate words measures a number of edits necessary to change the spelling of the word in the document into the word of the first set of one or more candidate words.

6. The method of claim 4, wherein a confidence score associated with a word of the second set of one or more candidate words is based on a confidence score of the word with respect to the first set of candidate words, a number of index classifications that the document to be indexed and the word are both associated with, a number of words that each index classification that the document is to be indexed in is associated with, and a number of times the word appears in the document.

7. The method of claim 1, wherein the document is a webpage.

8. The method of claim 1, wherein indexing the document with at least one word of the one or more candidate words comprises:
indexing the document with at least one word of the one or more candidate words and the actual spelling of the word in the document.

9. A computer-readable storage medium comprising a set of instructions for indexing a document, the set of instructions to direct a processor to perform the acts of:
determining whether a spelling of a word in a document to be indexed is incorrect;
generating one or more candidate words based on the spelling of the word in the document and a determined one or more index classifications of the document; and
indexing the document with at least one word of the one or more candidate words.

10. The computer-readable storage medium of claim 9, wherein generating one or more candidate words based on the spelling of the word in the document and the determined one or more index classifications of the document comprises:
generating a first set of one or more candidate words based on whether the spelling of the word in the document is at least one of a common misspelling of a word or a culture-based misspelling of the word;
for each candidate word of the first set of one or more candidate words, determining a confidence score associated with the candidate word; and
generating a second set of one or more candidate words based on the first set of one or more candidate words, the confidence scores associated with the first set of one or more candidate words, and the determined one or more index classifications of the document;
wherein the document is indexed with at least one word of the one or more candidate words based on the confidence score associated with each of the second set of one or more candidate words.

11. The computer-readable storage medium of claim 9, wherein indexing the document with at least one word of the second set of candidate words comprises:
indexing the document with at least one word of the second set of candidate words and the actual spelling of the word in the document

12. The computer-readable storage medium of claim 9, wherein the document is submitted to a search engine for indexing.

13. The computer-readable storage medium of claim 9, wherein the document is publicly available on the Internet.

14. The computer-readable storage medium of claim 9, wherein the document is a webpage.

15. A system for indexing a document, the system comprising:
an indexer operative to receive a document to be indexed;
a dictionary module in communication with the indexer, the dictionary module operative to determine whether a spelling of a word in the received document is spelled incorrectly;
a common misspelling module in communication with the indexer, the common misspelling module operative to generate a first set of one or more candidate terms based on whether the spelling of the word in the received document is a common misspelling of a word;
a context-based misspelling module in communication with the indexer, the context-based misspelling module operative to generate a second set of one or more candidate terms based on the first set of one or more candidate terms and one or more index classifications of the document;
wherein the indexer is further operative to index the received document with at least one word of the second set of one or more candidate words.

16. The system of claim 15, wherein the common misspelling module is further operative to, for each word of the first set of one or more candidate words, determine a confidence score associated with the word and the context-based misspelling module generates the second set of one or more candidate terms based on the first set of one or more candidate terms, the confidence score associated with each of the first set of one or more candidate terms, and the one or more index classifications of the document.

17. The system of claim 16, wherein the context-based misspelling module is further operative to, for each word of the second set of one or more candidate words, determine a confidence score associated with the candidate word and the indexer indexes the received document with at least one word of the second set of one or more candidate words based on the confidence score associated with each of the second set of one or more candidate words.

18. The system of claim 15, wherein the indexer indexes the received document with at least one word of the second set of one or more candidate words and the actual spelling of the word in the received document.

19. The system of claim 15, wherein the document is submitted to a search engine for indexing.

20. The system of claim 15, wherein the document is publicly available on the Internet.
